(19) United States
(12) Patent Application Publication
(10) Pub. No.: US 2007/0128401 A1
(43) Pub. Date: Jun. 7, 2007

(54) Electrode separator

(75) Inventors: Chien-Chung Kuo, Taichung County (TW); Fu-Cheng Chou, Taichung City (TW); Yi-Lin Chou, Taichung County (TW); Wan-Chen Tsai, Taichung County (TW); Ming-Chang Yu, Taichung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/293,102

(22) Filed: Dec. 5, 2005

(51) Int. Cl. B32B 3/00

(52) U.S. Cl. 428/57; 257/E51.022

(57) ABSTRACT

The present invention discloses an electrode separator, which is formed on a substrate that has strip-like first electrodes and is perpendicular to the first electrodes, wherein a common positive type photoresist material is firstly obliquely exposed and then vertically exposed and then developed to form the electrode separator by the two exposure steps. The electrode separator has a first lateral vertical to the bottom side of the electrode separator and a second lateral cooperating with the surface of the substrate to create an acute angle with one end of the top side having an overhanging portion. When the second electrodes are deposited, the overhanging portions can separate the metallic film of the second electrodes, and the metallic film of each second electrode is confined to between two electrode separators. Thus, the objective of separating the second electrode is achieved.

### FIELD OF THE INVENTION

The present invention relates to an electrode separator, particularly to the electrode separator of an organic light emitting diode (OLED) display panel.

### BACKGROUND OF THE INVENTION

Owing to OLED (Organic Light Emitting Diode) has the advantages of self-luminescence, thin thickness, rapid response, wide viewing angle, high resolution, high brightness, wide range of operation temperature, and applicability to a flexible panel, it is regarded as a new generation FPD (Flat Panel Display) technology succeeding Thin Film Transistor Liquid Crystal Display (TFT-LCD). The principle of OLED is that electrons and holes combine and become photons in a light-emitting layer. When electrons return from the excited state back to the ground state, the energy is released in the way of light, moreover, OLEDs of different light wavelengths can be fabricated. The first electrode of OLED is an Indium Tin Oxide (ITO) transparent conductive film, which is deposited on a transparent glass or plastic substrate by sputtering or vapor deposition, and the second electrode of OLED comprises magnesium, aluminum, lithium, etc. Multiple organic films are formed between two electrodes, including: a hole injection layer (HIL), a hole transport layer (HTL), a light-emitting layer, and an electron transport layer (ETL). In practical mass-production, other films may also be added according to the product's need.

As shown in FIG. 1, the electrode separator 2, which provides electric insulation between second electrodes, is formed on the substrate 1, which has strip-like first electrodes, and is perpendicular to the first electrodes. The inverted-trapezoid electrode separator of a Japanese company Tohoku Pioneer Electronic is the current mainstream of the separators of the OLED display panel. The electrode separator 2 is a strip-like barrier rib with two lateral overhanging portions. The cross-section of the electrode separator 2 is an inverted trapezoid, and the top side 2a thereof is greater than the bottom side 2b, and an included angle θ is created by the substrate 1 and each of two oblique laterals. The electrode separators 2 can automatically pattern the second electrodes and can be a plurality of supports during the deposition of the organic film.

The inverted-trapezoid electrode separator 2 is made of a negative type photoresist, which a chemically amplified photoresist material is processed with the steps of exposure, post exposure baking and development to obtain the desired inverted trapezoid. However, the chemically amplified photoresist material is very expensive and difficult to control the uniformity of chemical reaction. An included angle θ is created by the substrate 1 and the lateral of the inverted trapezoid is also hard to control. Sometimes, the developed inverted trapezoid almost becomes an inverted triangle, and the bottom side of the electrode separator 2b is too small to form a tough structure of the electrode separator 2. It is easily damaged by external force, and then brings about defects and affects the succeeding processes. Sometimes, incomplete development makes the included angle θ too large, and the second electrodes may have a short-circuit problem in the posterior vapor deposition process. Therefore, the chemically amplified photoresist material has the disadvantages of high cost and low yield.

Besides, owing to the limitation of the material characteristics of the chemically amplified photoresist and the unstable included angle θ, the width of the bottom side 2b of the electrode separator 2 cannot decrease too much lest the mechanical strength of the electrode separator 2 be too low; consequently, the width of the top side 2a is hard to decrease also. As the spacing between pixels is dependent on the width of the electrode separator 2, the width of the top side 2a will influence the light-emitting area for a given area of the substrate 1.

### SUMMARY OF THE INVENTION

The primary objective of the present invention is to provide an electrode separator, wherein the structure of the electrode separator is improved, and to reduce the influence of unstable chemical reaction of the photoresist material by the fundamental exposure principle. The electrode separator can be formed merely with a common positive type photoresist material. The yield can be promoted, and the fabrication cost can be decreased.

Another objective of the present invention is to provide an electrode separator, wherein the structure of the electrode separator is improved, and the width of the electrode separator is decreased; the light-emitting area is increased, and the aperture ratio is also increased. OLED display panel can obtain a further better display performance.

The present invention is an electrode separator, wherein an electrode separator is formed on a substrate, which has patterned first electrodes, and the formed electrode separator is perpendicular to the first electrodes. In the present invention, a common positive type photoresist material is firstly obliquely exposed and then vertically exposed, and consequently to form the electrode separator by the two exposure steps. The electrode separator comprises a bottom side contacting the substrate and a top side parallel to the bottom side, and the width of the top side is greater than that of the bottom side. The electrode separator also comprises a first lateral vertical to the bottom side and a second lateral opposite to the first lateral. The second lateral and the surface of the substrate create an acute angle, and an overhanging portion of the electrode separator is thus formed on the second lateral. The electrode separators not only can automatically pattern the second electrodes but also can be the supports during the deposition of the organic film.

### BRIEF DESCRIPTION OF THE DRAWINGS

FIG. 1 is a schematic diagram of a conventional electrode separator.

FIG. 2 is a schematic diagram of the electrode separator according to the present invention.

FIG. 3A to FIG. 3C are schematic diagrams showing the steps of a fabrication process of the electrode separator according to the present invention.

FIG. 4A to FIG. 4E are schematic diagrams showing the steps of another fabrication process of the electrode separator according to the present invention.

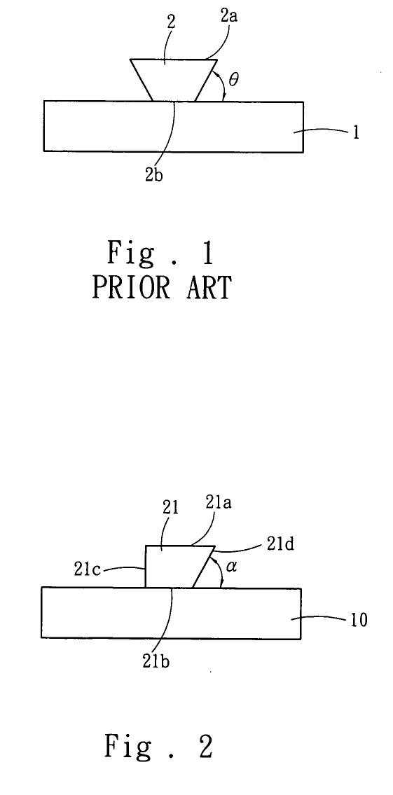

### DETAILED DESCRIPTION OF THE PREFERRED EMBODIMENTS

The technical contents of the present invention are to be described below in detail in cooperation with the attached drawings.

Refer to FIG. 2 a cross-section view schematically showing the electrode separator according to the present invention. As showing in FIG. 2, the electrode separator 21 of the present invention, which is used to separate the second electrode, is formed on a substrate 10 that has patterned first electrodes, and the formed electrode separator 21 is perpendicular to the first electrodes. The electrode separator 21 comprises a bottom side 21b and a top side 21a. The bottom side 21b disposed on the interface between the substrate 10 and the electrode separator 21. The top side 21a parallel to the bottom side 21b with the width of the top side 21a greater than that of the bottom side 21b.

A first lateral 21c, which is a lateral of the electrode separator 21, is vertical to the bottom side 21b. A second lateral 21d, which is another later opposite to the first lateral 21c, cooperates with the surface of the substrate 10 to create an acute angle α with an overhanging portion formed thereby. The acute angle α ranges from 15°to 75°, and the included angle α is preferred to range from 30° to 60°.

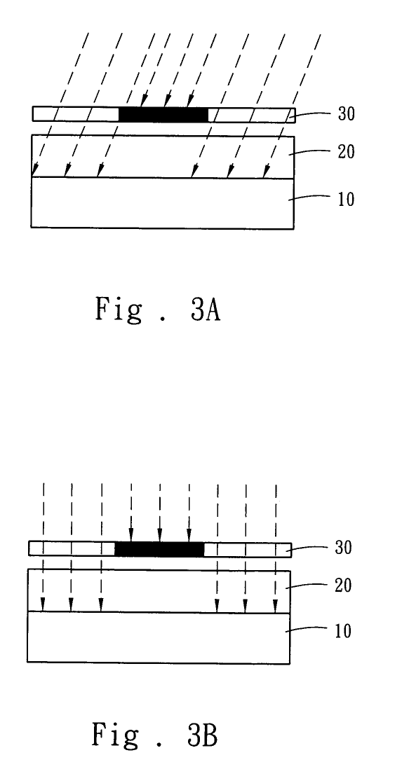

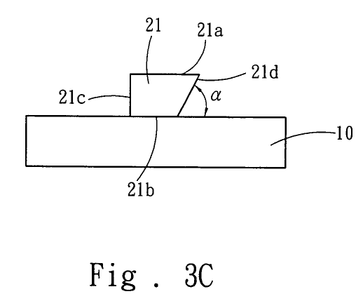

The fabrication methods of the electrode separator of the present invention are described below. Refer to from FIG. 3A to FIG. 3C for a first fabrication method of the electrode separator of the present invention. In the first fabrication method, the electrode separator 21, which is used to separate the second electrodes in the succeeding fabrication process, is formed on a substrate 10 whereon horizontal strip-like first electrodes have been formed, and the formed electrode separator 21 is perpendicular to the first electrodes. The cross-section of the electrode separator 21 is an inverted trapezoid with one right angle and the other acute angle.

The first fabrication method of the electrode separator 21 of the present invention comprises the following procedures:
(a) A separator material 20 is applied onto the substrate 10, and the separator material 20 is a common positive type photoresist material. Next, a photomask 30, which has the electrode separator patterns 31, is used to perform an oblique exposure on the separator material 20, as shown in FIG. 3A. In this procedure, the angle of the oblique exposure determines the acute angle α created by the second lateral 21d of the electrode separator 21 and the surface of the substrate 10.
(b) Next, the identical photomask 30 is used to perform a vertical exposure on the separator material 20, as shown in FIG. 3B. This procedure makes the first lateral 21c of the electrode separator 21 vertical to the bottom side 21b.
(c) Next, a development procedure is performed on the exposed separator material 20 to form the electrode separator 21 on the substrate 10, as shown in FIG. 3C; the cross-section of the electrode separator 21 is an inverted trapezoid with one right angle and the other acute angle.

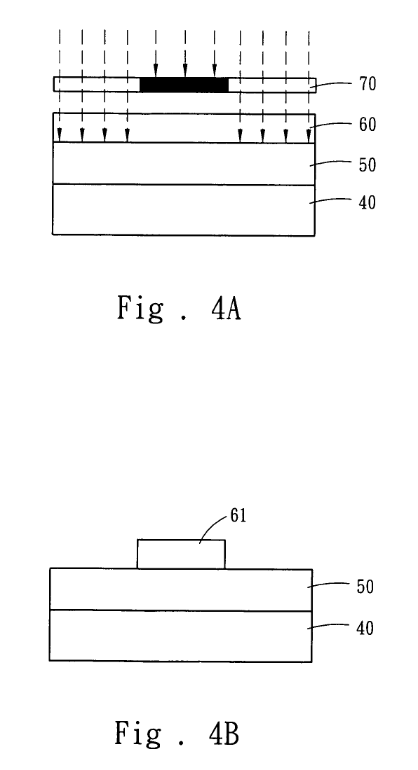

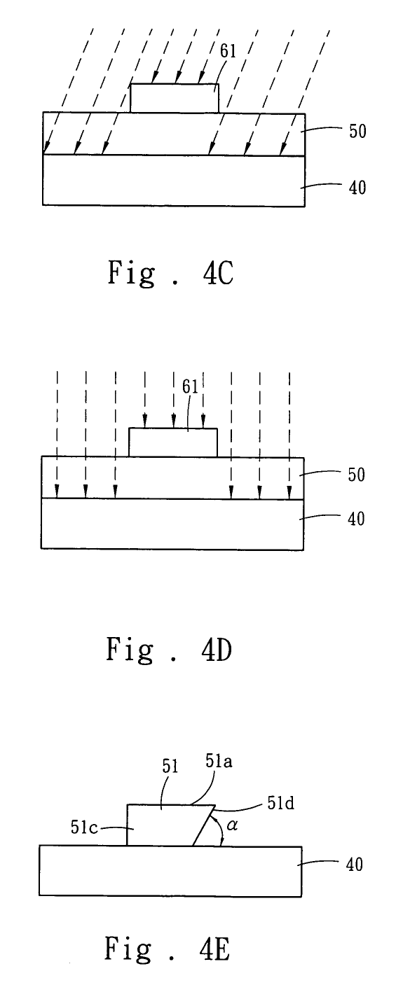

Refer to FIG. 4A to FIG. 4E for a second fabrication method of the electrode separator of the present invention. An electrode separator 51, which is used to separate second electrodes in the succeeding fabrication process, is perpendicular to the first electrodes as shown in FIG. 4E, and formed on a substrate 40 which has the first electrodes. The cross-sectional view of the electrode separator 51 is an inverted trapezoid with one right angle and the other acute angle.

The second fabrication method of the electrode separator 51 of the present invention comprises the following procedures:
(a) A separator material 50 is formed on the substrate 40, and the separator material 50 is an inorganic material or an organic material, as shown in FIG. 4A. Next, a photoresist layer 60 is applied onto the separator material 50. Next, a photomask 70, which has the electrode separators patterns 71, is used to perform a photolithography process on the separator material 50 in order to form a photoresist pattern 61 on the separator material 50, as shown in FIG. 4B.
(b) The photoresist pattern 61 is to be used as a shield mask in the succeeding procedures. The photoresist pattern 61 is used as a shield mask to perform an anisotropic and oblique etching on the separator material 50, as shown in FIG. 4C. In this procedure, the angle of the oblique etching determines the acute angle α created by the second lateral 51d and the surface of the substrate 40.
(c) Next, the identical photoresist pattern 61 is used as a shield mask to perform an anisotropic and vertical etching on the separator material 50, as shown in FIG. 4D. This procedure makes the first lateral 51c vertical to the bottom side 51b.
(d) Next, a stripping procedure is performed on the photoresist pattern 61 to form the electrode separator 51 on the substrate 40, as shown in FIG. 4E; the electrode separator 51 has an overhanging portion on one lateral.

In the present invention, the electrode separator 21 is fabricated via two exposure steps, and the electrode separator 51 is fabricated via two etching steps. The electrode separator 21, 51 has a lateral (the first lateral 21c, 51c) vertical to the bottom side 21b, 51b. The lateral (the second lateral 21d, 51d) opposite to the vertical lateral is an oblique plane. The oblique plane and the surface of the substrate 10, 40 create an acute angle α, and an overhanging portion projects from one end of the top side 21a, 51a. After the vapor deposition of the organic materials, the second electrode is deposited and then separated because the overhanging portion projecting from one end of the top side 21a, 51a of the electrode separator 21, 51 further can separate the metallic film of the second electrode formed in between two electrode separators 21, 51.

In comparison with that the conventional electrode separator is made of a chemically amplified photoresist material, the electrode separator 21 is made of a positive type photoresist material, and the electrode separator 51 is made of an inorganic material or an organic material. Thus, the material cost can be reduced obviously. Besides, the chemical reaction of a common positive type photoresist material is more easily controlled than that of a chemically amplified photoresist material. Thus, non-uniform chemical reaction is hard to occur in the present invention, and the angle α created by the oblique plane of the electrode separator 21, 51 and the surface of the substrate 10, 40 can be controlled easily. Therefore, the mechanical strength of the electrode separator 21, 51 is also controllable. In the succeeding processes, such as the selective formation of organic films, the electrode separator will not be easily damaged by external force; thus, the yield can be promoted obviously.

As one lateral of the electrode separator 21, 51 is a vertical plane, one overhanging portion is omitted in the top side 21a, 51a of the electrode separator 21, 51 of the present invention. Therefore, when the width of the bottom side 21b, 51b of the electrode separator 21, 51 of the present invention is equal to that of the conventional electrode separator, the width of the top side 21a, 51a is smaller than the top side 2a of the conventional electrode separator. Then, for a given area, the light-emitting area of pixels of the present invention is greater than that of the conventional technology, i.e. in the present invention, a single pixel has a greater aperture ratio. Furthermore, the OLED display will be higher resolution. Consequently, the entire OLED display panel can have a better display performance.

Those described above are only the preferred embodiments of the present invention and not intended to limit the scope of the present invention. Any equivalent modification and variation according to the spirit of the present invention is to be included within the scope of the present invention.

What is claimed is:

1. An electrode separator, comprising:
a bottom side, contacting a substrate;
a top side, parallel to the bottom side with the width of the top side greater than that of the bottom side;
a first lateral, vertical to the bottom side; and
a second lateral, opposite to the first lateral with an acute angle created between the second lateral and the surface of the substrate.

2. The electrode separator according to claim 1, wherein the electrode separator is installed on the substrate that has patterned first electrodes and is perpendicular to the first electrodes.

3. The electrode separator according to claim 1, wherein the electrode separator is applied to organic light emitting diode displays.

4. The electrode separator according to claim 1, wherein the acute angle ranges from 15° to 75°.

5. The electrode separator according to claim 2, wherein the acute angle is preferred to range between 30° and 60°.
